(19) United States
(12) Patent Application Publication
(10) Pub. No.: US 2024/0258599 A1
(43) Pub. Date: Aug. 1, 2024

(54) Drive Battery for a Motor Vehicle, and Motor Vehicle Comprising Such a Drive Battery

(71) Applicant: Bayerische Motoren Werke Aktiengesellschaft, Muenchen (DE)

(72) Inventors: Thomas HARSCH, Muenchen (DE); Christian KARGES, Muenchen (DE); Alexander KROHMER, Muenchen (DE)

(21) Appl. No.: 18/290,864

(22) PCT Filed: Jul. 22, 2022
(86) PCT No.: PCT/EP2022/070695

§ 371 Date: Jan. 22, 2024

(30) Foreign Application Priority Data
Jul. 23, 2021 (DE) 10 2021 119 168.8

(51) Int. Cl. H01M 10/613; B60L 50/64; H01M 50/213; H01M 50/249

(52) U.S. Cl. CPC H01M 10/613; B60L 50/64; H01M 50/213; H01M 50/249

(57) ABSTRACT

A drive battery for a motor vehicle has a drive battery housing which has a top wall and a bottom wall. Located in the drive battery housing are a battery cell layer having a plurality of battery cells arranged vertically and next to one another and a support layer, which can also be referred to as a degassing layer, spacer layer, or deformation layer. The battery cell layer is bonded to the top wall by way of an upper adhesive layer and to the support layer by way of a lower adhesive layer, in particular over a large area, for example over its entire surface. The support layer is also bonded to the bottom wall by way of a further adhesive layer.

### BACKGROUND AND SUMMARY

The present invention relates to a drive battery for a motor vehicle, having a drive battery housing, and to a method for producing a drive battery of this type.

A motor vehicle with an electric drive usually has a drive battery which has a drive battery housing in which are assembled a plurality of battery modules having battery cells, an electrics/electronics unit and a cooling installation. The drive battery housing in turn is assembled below a floor pan on a vehicle body. The known drive battery housing is composed of aluminum, for example, and has lateral supports, a cover and a base. The lateral supports are embodied, for example, as extruded profiles or castings. Further longitudinal members and crossmembers are optionally also provided in the battery housing, so as to impart a certain degree of stiffness and collision resistance capability to the drive battery.

As is shown in DE 10 2017 223 407 A1, a known drive battery housing has longitudinal members and a plurality of crossmembers which run between the longitudinal members. Furthermore, the drive battery housing has an upper wall and a lower wall, each being connected at least to an outer support structure, thus to the outer longitudinal members and the outer crossmembers. The longitudinal members and also the crossmembers are formed from extruded profiles. The drive battery housing is assembled below a body floor.

It is the object of the present invention to achieve a drive battery, or a motor vehicle having a drive battery of this type, wherein the drive battery has a higher output density per unit of installation space and simultaneously is stiffer and stronger.

This object is achieved by a drive battery, or a motor vehicle having such a drive battery, having the features of the independent claims. Advantageous design embodiments of the invention are set forth in the dependent claims.

According to the invention, the drive battery for a motor vehicle has a drive battery housing which has a cover wall and a base wall. Disposed in the drive battery housing are a battery cell layer having a multiplicity of battery cells, which are arranged vertically and next to one another, and a support layer which may also be referred to as a degassing layer, a spacer layer or a deformation layer. The battery cell layer is adhesively bonded, in particular across a large area, i.e. across its entire surface, to the cover wall by means of an upper adhesive layer and to the support layer by means of a lower adhesive layer. Furthermore, the support layer is adhesively bonded to the base wall by means of a further adhesive layer.

As a result, a very compact drive battery which saves installation space in the vertical direction, i.e. in the Z-direction in the vehicle coordinate system, is achieved. The battery cells can be embodied so as to be relatively high in comparison to the overall height of the drive battery, a storage capacity of the drive battery being increased as a result. Owing to the cover wall, the battery cell layer, the support layer and the base wall being adhesively bonded to one another in sandwich-like fashion, the drive battery overall has a high stiffness in terms of torsion and bending such that no further support construction is required within the drive battery. All layers of the drive battery contribute toward stiffness and strength of the drive battery. The drive battery is configured for installation in the motor vehicle in such a manner that the cover wall is configured at the top and the base wall is configured at the bottom. In this way, the base wall in the installed state preferably forms an underbody of the motor vehicle.

The support layer has the function of a spacer layer such that a specific spacing exists between the battery cell layer and the base wall, so that there is sufficient deformation space available when driving over a bollard or the like, i.e. in the event of a collision from below. For this purpose, the support layer is conceived to sufficiently dissipate collision energy by way of deformation. As a result of the support layer being adhesively bonded, the latter, despite its deformation capability, contributes toward stiffness and strength of the drive battery.

The upper adhesive layer and/or the lower adhesive layer and/or the further adhesive layer can be formed by a foamed material. A foamed material of this type is also referred to as structural foam. The foamed material can be polyurethane.

According to one refinement, the battery cell layer is formed from a multiplicity of battery cells, wherein each battery cell is composed of a battery cell housing and a jelly roll which is received in the battery cell housing. An upper end side of the battery cell housings is in each case adhesively bonded to the cover wall, and a lower end side of the battery cell housings is in each case adhesively bonded to the support layer.

In this way, the multiplicity of battery cell housings form a multi-chamber structure, which is similar to a honeycomb structure and, as a result of being adhesively bonded to the other layers of the drive battery, significantly increase flexural stiffness and torsional stiffness.

The battery cell housings have thin walls and are formed from metal, for example aluminum or steel.

Adjacent battery cell housings among one another can be adhesively bonded to one another on the shell face.

In particular, adjacent battery cell housings among one another can be adhesively bonded on the shell face by a foamed material. The foamed material can be polyurethane foam.

The battery cell can be a so-called round cell, i.e. circular-cylindrical, or else a so-called prismatic cell, i.e. substantially cuboid.

As an alternative to the embodiment with mutually separated battery cell housings, the battery cell layer can also be formed from an integrally configured multi-chamber structure—the latter running transversely, in particular perpendicularly, to the plane of the cover wall or the base wall, respectively—having a multiplicity of vertical chambers in which one jelly roll or else a plurality of jelly rolls is/are in each case received. An upper end side of the multi-chamber structure herein is adhesively bonded to the cover wall, and a lower end side of the multi-chamber structure is adhesively bonded to the support layer. The multi-chamber structure can be produced by extrusion, for example. The individual chambers can have a square or any other polygonal cross section, for example similar to honeycombs.

The integrally configured multi-chamber structure can impart to the drive battery an even greater stiffness at a reduced weight. Furthermore, a larger number of jelly rolls can be accommodated on the same area as a result.

According to a further refinement, the drive battery has a battery cell contacting system which is embedded in the upper adhesive layer and/or in the lower adhesive layer.

The battery cell contacting system is accommodated in the adhesive layer so as to be protected—for example protected against corrosion. At the same time, the battery cell contacting system as a result can contribute toward the above-described stiffness and strength of the drive battery.

The battery cell contacting system by way of both contacting terminals is preferably embedded in the upper adhesive layer. As a result, the battery cell contacting system is accommodated so as to be particularly well protected. In particular, it is herein better protected in the event of collisions of the base wall.

Furthermore advantageously, one degassing opening is formed in each battery cell in that side that faces the support layer.

In this way, the degassing openings of the battery cells, in the installed state of the drive battery, are aligned downward and not in the direction of the cover wall and thus of a passenger cabin. There is more downward space for discharging the gases, and it can be readily prevented that gases flow in the direction of the passenger cabin.

Should the degassing openings of the battery cells be formed on the lower side of the latter, thus so as to face the support layer, a clearance, i.e. a degassing space or void, is preferably provided in the support layer in each case in the region of the degassing opening. Adjacent clearances can be suitably connected to one another by degassing ducts so that gas escaping from a battery cell can easily be directed onward and sufficient space is available.

The support layer can be formed from a foamed material, in particular a foamed plastics material, for example foamed polyurethane.

When adhesively bonded to the adjacent layers across the entire area, a foamed material is light, but can nevertheless sufficiently contribute toward the stiffness and strength of the drive battery. Furthermore, the foamed material can very well serve for dissipating collision energy by deformation.

According to a further refinement, the cover wall can be configured as a heat exchanger for the temperature control of the battery cell layer.

In the case of an assembled drive battery, the cover wall herein can also be utilized as a temperature-control face for the passenger cabin.

According to one preferred refinement, the support layer is configured as a heat exchanger for the temperature control of the battery cell layer.

Alternatively or additionally, heat-exchange devices can furthermore be provided between the battery cells. The heat-exchange devices can be provided on shell faces, thus not on the end sides, of the battery cells. This is also referred to as inter-cell temperature control.

As a result of the temperature control by way of the shell face, a higher temperature-control output can be implemented so that the drive battery reaches the desired target operating temperature faster and can be correspondingly rapidly cooled in the case of an increased consumption of output, such that the target operating temperature is not exceeded.

The cover wall and the base wall are preferably connected to one another by a flange connection. A fluid-tight drive battery housing can be formed herein by a corresponding seal, for example on the flange connection. For this purpose, the cover wall and/or the base wall can be configured in the shape of a tub, or be a constituent part of a tub, respectively.

A heat protection layer, for example a mica plate, can be disposed on an inner side of the base wall. The base wall can be adhesively bonded to the heat protection layer or be otherwise integrally configured with the heat protection layer. The heat protection layer in turn is preferably adhesively bonded to the support layer.

The heat protection layer serves as heat protection for the base wall, in particular in the event of hot gases exiting the battery cells. This is particularly advantageous when the base wall is composed of aluminum, an aluminum alloy or fiber-reinforced plastics material. This can furthermore be advantageous when degassing openings of the battery cells are disposed on a lower side, for example a lower end side, of the battery cells.

The cover wall and/or the base wall can be composed of aluminum or an aluminum alloy or of steel. Or else, the cover wall and/or the base wall can be composed of a fiber-reinforced plastics material, for example a carbon fiber-reinforced plastics material.

The cover wall and/or the base wall on the inside can in each case be provided with an electrical insulation layer, for example in the form of a coating. This is advantageous when an electrical insulation in relation to the cover wall and/or base wall is required, and the cover wall and/or base wall are electrically conductive.

The upper, lower and/or further adhesive layer can be composed of thermally conductive adhesive when an improved heat exchange is required for discharging from, or supplying heat to, the battery cells.

The drive battery is preferably configured to be assembled on a floor pan of a body of the motor vehicle, wherein the floor pan has a left longitudinal member and a right longitudinal member, wherein the drive battery, or the drive battery housing, is assembled on the floor pan from below, respectively, and wherein the cover wall at least in portions forms a base of the floor pan. The base wall preferably forms an underbody of the motor vehicle.

The drive battery according to the invention can be embodied and connected to the floor pan in such a manner that the drive battery increases a body stiffness for driving operation of the motor vehicle and that the drive battery increases a body strength for a load arising in the event of a collision of the motor vehicle.

A further aspect of the present invention relates to a motor vehicle, in particular a passenger motor vehicle or a commercial motor vehicle, having a drive battery as described above.

The motor vehicle has an electric drive. A body of the motor vehicle has a floor pan having a left longitudinal member and a right longitudinal member. Body longitudinal members of this type are also referred to as side skirts or outer, lower frame rails. The drive battery has a drive battery housing, wherein the drive battery, or the drive battery housing, respectively, is assembled on the floor pan from below. The assembled drive battery, or the assembled drive battery housing, respectively, at least in portions forms a base of the floor pan.

As a result, the drive battery replaces the base of the floor pan. As a result, the motor vehicle, i.e. the body, in particular the floor pan, becomes lighter and requires fewer components. Furthermore, an installation space in the vehicle vertical direction (Z-direction) can be reduced as a result, or higher battery cells can be installed, respectively.

The drive battery advantageously extends substantially across an entire width of the floor pan, i.e. substantially across an entire installation space between the left longitudinal member and the right longitudinal member.

As a result, sufficient battery cells can be accommodated in the drive battery, and a sufficiently large part of the base of the floor pan can be replaced.

Furthermore, the drive battery housing can extend in a region, or across an ideally large region, respectively, between a front axle and a rear axle of the motor vehicle. The drive energy housing advantageously extends from a front bulkhead (of a passenger cabin), or from below the front bulkhead, up to front ends of a left wheel arch and of a right wheel arch. Furthermore, the drive battery housing can extend to below a second row of seats of the motor vehicle. In other words, the drive battery housing can run and be disposed at least from a region between a front body pillar (an A-pillar) and a rear body pillar (in particular a C-pillar).

According to a preferred refinement of the present invention, the drive battery and the floor pan form in an interacting manner a fluid-tight base of a passenger cabin of the motor vehicle. In particular, fluid tightness of the passenger cabin in the downward direction is established only by the interaction between the drive battery housing and the floor pan—in the absence of the drive battery housing, the floor pan would not have a fluid-tight base, or the floor pan itself is not fluid-tight in the downward direction, respectively.

The drive battery housing thus replaces the function of a continuous fluid-tight base of the floor pan. In this context, the term “fluid-tight” does not actually preclude that the floor pan or the drive storage housing in interaction with the floor pan has closable openings for feeding through lines, a water drain, or the like. “Fluid-tight” in particular means “liquid-tight”.

A seal or a sealing adhesive can be suitably disposed between the drive battery housing and the floor pan, such that the assembled drive battery housing completely seals the floor pan in the downward direction.

The seal can be formed from butyl, for example. The seal can be configured as a flat seal, a lip seal, or a profiled seal.

The drive battery housing advantageously has an encircling sealing flange which can also simultaneously be an assembly flange, having a continuously encircling sealing face for sealing the drive storage housing in relation to the floor pan.

The encircling sealing flange is advantageously situated in a plane, i.e. in a plane parallel to an xy-plane of a vehicle coordinate system. Tightness can be readily established as a result.

According to an advantageous refinement of the motor vehicle according to the invention, the floor pan can have a front crossmember structure and a rear crossmember structure, wherein the drive battery is assembled on the left longitudinal member and on the right longitudinal member as well as on the front crossmember structure and on the rear crossmember structure. In this case, the aforementioned sealing flange bears on corresponding flange sealing faces of the longitudinal members and of the crossmember structures.

The floor pan between the front crossmember structure and the rear crossmember structure advantageously has at least one further crossmember which is in each case connected to the left longitudinal member and the right longitudinal member, or runs between the left longitudinal member and the right longitudinal member, respectively. The further crossmember can be a seat crossmember or a heelboard crossmember. The floor pan advantageously has a plurality of further crossmembers, a void being formed in each case therebetween such that the floor pan is open in the downward direction. The seat crossmember or members is/are advantageously disposed in the region behind the bulkhead up to a B-pillar, and serve for fastening a front seat row, i.e. front seats, and for providing strength of the floor pan in the transverse direction in the event of a collision. The heelboard crossmember is usually disposed in the region of a front end of a second seat row, and serves for fastening the second seat rows and likewise for providing strength of the floor pan in the transverse direction in the event of a collision.

The drive battery is preferably assembled on the further crossmember, in particular by means of a screw connection. Additionally or alternatively, the drive battery can be connected, i.e. be adhesively bonded, to the crossmember by an adhesive connection.

As a result, an overall stiffness of the floor pan with the drive battery can be further increased, and a vibration behavior of the motor vehicle in the driving operation can also be positively influenced. As a result, the drive battery furthermore supports the crossmembers, or crossmember structures, in relation to buckling in the event of a side collision, respectively.

According to a further refinement, the floor pan between the front crossmember structure and the rear crossmember structure or between the front crossmember structure and a further crossmember does not have a floor panel—in other words, the floor pan is advantageously configured without a floor panel, or is free of a floor panel. In this way, a larger region of the floor pan is configured to be open.

The term “configured to be open” means that a free, open region which forms a through opening is configured, so that the floor pan is configured to be open in the downward direction.

Alternatively or additionally, the floor pan between the left longitudinal member and the right longitudinal member can have at least one further longitudinal member which is connected to the front crossmember structure and/or the rear crossmember structure. For example, the further longitudinal member can be disposed in the center and form a central tunnel there.

The floor pan advantageously does not have a floor panel at all.

A base panel is usually a monocoque component, in particular a planar component, optionally a single-layer component, which does not have or form a hollow section or the like, and therefore does not form a body member.

40% to 85% of the area between the right longitudinal member and the left longitudinal member and the front crossmember structure and the rear crossmember structure are preferably configured to be open, i.e. without a base panel and without a crossmember.

In a method according to the invention for producing a drive battery for a motor vehicle, a cover wall, optionally an upper or/and lower battery cell contacting system, a battery cell layer, and optionally a support layer, are disposed on top of one another (step of disposing). Alternatively, a base wall, a support layer, optionally the upper or/and lower battery cell contacting system, and the battery cell layer are disposed on top of one another (step of disposing). Thereafter, in a further method step (step of filling), intermediate spaces between the individual layers and the battery cells are filled with a liquid foam precursor product, in particular a bi-component mixture or a multi-component mixture. In a further method step (step of foaming), the bi-component mixture or multi-component mixture, i.e. the foam precursor product, reacts after the filling procedure and forms a foamed material, in particular polyurethane foam, such that the base wall, optionally the upper or/and lower battery cell contacting system, the battery cell layer, and optionally the support layer, are adhesively bonded to one another, or the cover wall, the support layer, optionally the upper or/and lower battery cell contacting system, and the battery cell layer are adhesively bonded to one another, respectively.

As a result, adhesive bonding of the individual layers of the drive battery that participate in the step of disposing can take place in a particularly simple manner and in one operating step.

When filling with the liquid foam precursor product, the base wall, or the cover wall, is preferably at the bottom here, and optionally the battery cell contacting system, the battery cell layer, and optionally the support layer, are accordingly stacked/disposed on top.

As a result, the liquid foam precursor product can flow from the top to the bottom by gravity and is suitably distributed as a result.

The method described can be applied in an analogous manner to manufacturing all drive batteries described here. In other words, the method can be applied to a drive battery having a battery cell contacting system disposed at the top or a battery cell contacting system disposed at the bottom or a battery cell contacting system disposed on both sides of the battery cell. Likewise, the method can be implemented in drive batteries having the different heat exchanger systems on the shell face of the battery cells and/or on the end faces that are described here.

In the method according to the invention, the participating layers can be mutually compressed, in particular by way of a corresponding tool, during the step of foaming. In this way, the layers are not pushed away from one another by the foam, and the adhesive effect is improved.

Spacers, which are either configured integrally with a respective layer or are configured separately from the layers, can be provided between the layers.

As a result, specified dimensions of the drive battery can be better adhered to. The upper adhesive layer and optionally the lower adhesive layer and optionally the further adhesive layer thus have a defined dimension in the vertical direction (z-direction in the vehicle coordinate system) of the drive battery.

In a further preferred method step, after the step of foaming, the base wall, or alternatively the cover wall, can be attached by, for example, a further adhesive layer which in this instance preferably is not a foamed material (attaching the base wall, or the cover wall, respectively). Likewise, if the spacer layer has not already been disposed in the step of disposing, the spacer layer can be attached by a lower adhesive layer which in this instance preferably is not a foamed material.

Likewise, the base wall, or alternatively the cover wall, can already be disposed in the step of disposing. In other words, all layers of the drive battery, including the base wall and the cover wall, are disposed on top of one another in the step of disposing. Thereafter, the step of foaming is carried out. In the step of foaming, all layers of the drive battery are advantageously mutually braced or mutually compressed here, so that the individual layers are not pushed away from one another during foaming. Once all layers of the drive battery have thus been adhesively bonded to one another by foaming, no further step is required thereafter for attaching further layers.

Refinements of the invention set forth above can be combined with one another in an arbitrary manner as far as possible and expedient.

### BRIEF DESCRIPTION OF THE DRAWINGS

FIG. 1 schematically shows a sectional view of a drive battery according to an exemplary embodiment of the present invention.

FIG. 2 schematically shows a perspective view of a motor vehicle having a body and a drive battery prior to assembling the drive battery on the body according to the exemplary embodiment of the present invention.

FIG. 3 schematically shows a sectional view of the motor vehicle having the body and the assembled drive battery according to the exemplary embodiment of the present invention.

FIG. 4 schematically shows a perspective view from below of the motor vehicle having the body without the drive battery.

FIG. 5 schematically shows a perspective view from above of the motor vehicle having the body and the assembled drive battery according to the exemplary embodiment of the present invention.

### DETAILED DESCRIPTION OF THE DRAWINGS

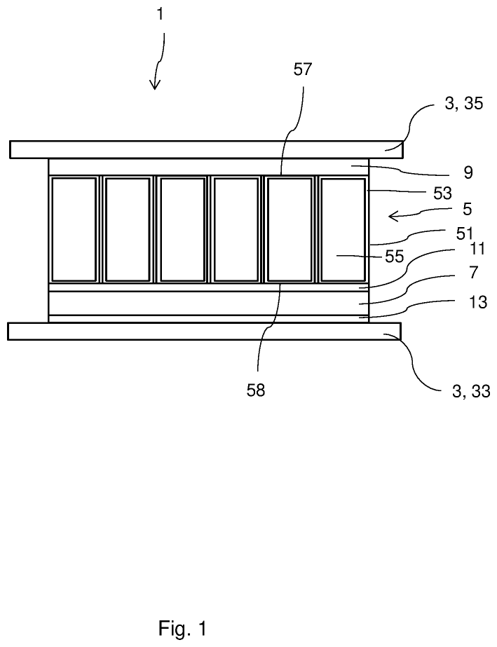

Hereunder is a description of an exemplary embodiment of the present invention with reference to FIGS. 1 to 5.

Very schematically shown in a sectional view in FIG. 1 is a drive battery 1 according to the exemplary embodiment of the present invention. The drive battery 1 is configured to be assembled on a body of a passenger motor vehicle. The drive battery 1 is a so-called high-voltage accumulator for driving an electric drive motor of the passenger motor vehicle. The drive battery 1 is constructed in sandwich-like fashion from a plurality of layers. Beginning at the top, the drive battery 1 has a cover wall 35 as part of a drive battery housing 3. The cover wall 35 by way of an upper adhesive layer 9 is connected in a planar manner to an upper side of a battery cell layer 5. Furthermore, a lower side of the battery cell layer 5 by way of a lower adhesive layer 11 is connected in a planar manner to a support layer 7. The support layer 7 in turn, on the lower side thereof, by way of a further adhesive layer 13 is connected to a base wall 33 of the drive battery housing 3.

The battery cell layer 5 is composed of a multiplicity of battery cells. Each battery cell 51 in turn is composed of a battery cell housing 53 of aluminum or steel, in which a jelly roll 55 is received. The battery cells 51 are so-called round cells, having a circular-cylindrical shape. The battery cells 51 are disposed ends-up, i.e. vertically, in the battery cell layer 5 such that the battery cells 51 are mutually contiguous by way of the shell faces thereof. The upper end sides of the battery cells 51 are in each case connected to the adhesive layer 9 and thus to the cover wall 35. The lower end sides of the battery cells 51 are in each case connected to the adhesive layer 11 and thus to the support layer 7.

A battery cell contacting system, which is not illustrated in more detail and suitably connects the terminals of the battery cells 51 to one another, is embedded in the upper adhesive layer 9. The adhesive surrounds conductor tracks of the battery cell contacting system. Both terminals of the battery cells 51 are situated on the upper end side of the battery cells 51.

Degassing openings are formed on the lower end side of the battery cells 51. Clearances, or degassing spaces, are configured in the support layer 7 so as to be complementary to the degassing openings of the battery cells 51. Accordingly, the adhesive layer 11 also has clearances. The clearances are suitably connected to one another by way of degassing ducts, so that gas escaping from a battery cell 51 can be discharged by way of the degassing ducts of the support layer 7.

The support layer 7 is composed of a foamed polyurethane and is deformable. In the event of a collision of the base of the drive battery 1 installed in the motor vehicle, the base wall 33 conjointly with the support layer 7 is optionally deformed in the process and can in this way collision energy by deformation in order to protect the battery cell layer 5.

The adhesive layers 9, 11, 13 of the exemplary embodiment can be formed by polyurethane foam.

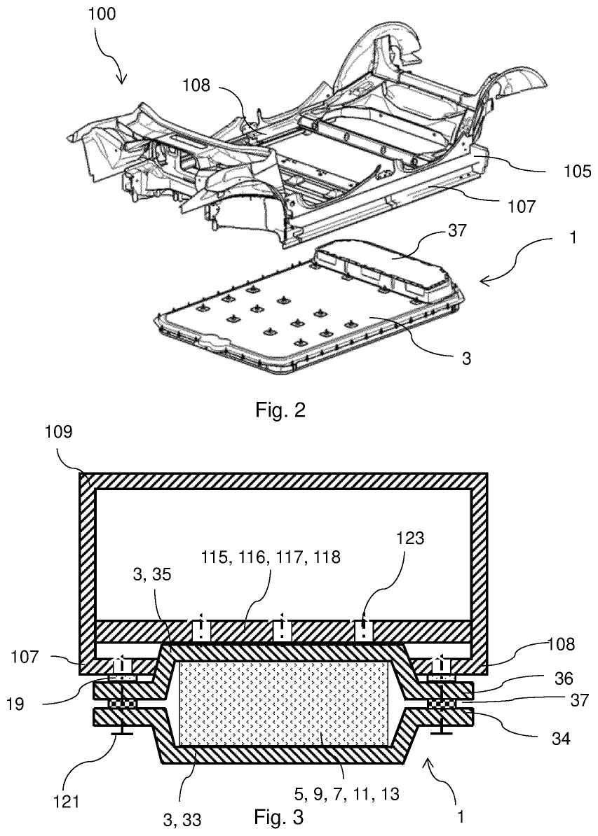

The state prior to assembly of the drive battery 1 on a body 100 is shown in FIG. 2. The body 100 is not completely illustrated in FIG. 1, but substantially only a floor pan 105 of the body 100. The body 100, or the floor pan 105, has a left side skirt 107 and a right side skirt 108, i.e. longitudinal member. The drive battery 1 has a drive battery housing 3, as described above, which across its entire extent has substantially an identical height—with the exception of an attached ancillary housing in the rear region of the drive battery 1. The battery cell layer 5 is accommodated in the drive battery housing 3. For example, a power electronics unit is accommodated in the ancillary housing. The drive battery 1 is assembled on the floor pan 105 from below by means of screw connections 121, 123 and optionally additionally by adhesively bonded connections.

A very schematic sectional view along a y-direction and a z-direction of the body 100 is shown in FIG. 3. The section runs through a passenger cabin 109 of the motor vehicle. The side skirts 107, 108 are illustrated at the lower left and lower right in FIG. 2, the drive battery housing 3 being assembled thereon by means of screw connections 121 from below. In particular, the drive battery housing 3 on its encircling flange 34, 36 is assembled on the floor pan 105 with a seal 19 disposed therebetween. Furthermore, a crossmember 115, 116, 117, 118 of the floor pan 105 is schematically illustrated in the sectional view. The drive energy storage housing 3 is connected to the crossmember 115, 116, 117, 118 by means of screw connections 123 and is additionally adhesively bonded.

The assembled drive energy storage housing 3 at least in portions forms a base of the floor pan 105 and extends across an entire width of the floor pan 105 between the left side skirt 107 and the right side skirt 108. The passenger cabin 109 is tight in the downward direction as a result of the seal 19.

As a result of the sandwich-like construction of the drive battery 1 and the adhesive bonding of the layers to one another, the drive battery 1 is highly stiff in terms of bending and torsion. As a result, the assembled drive battery 1 can correspondingly interact with the floor pan 105 such that the motor vehicle overall has a higher flexural and torsional stiffness. In other words, as a result of the construction described above, the drive battery 1 can particularly well assume a structural function of the body.

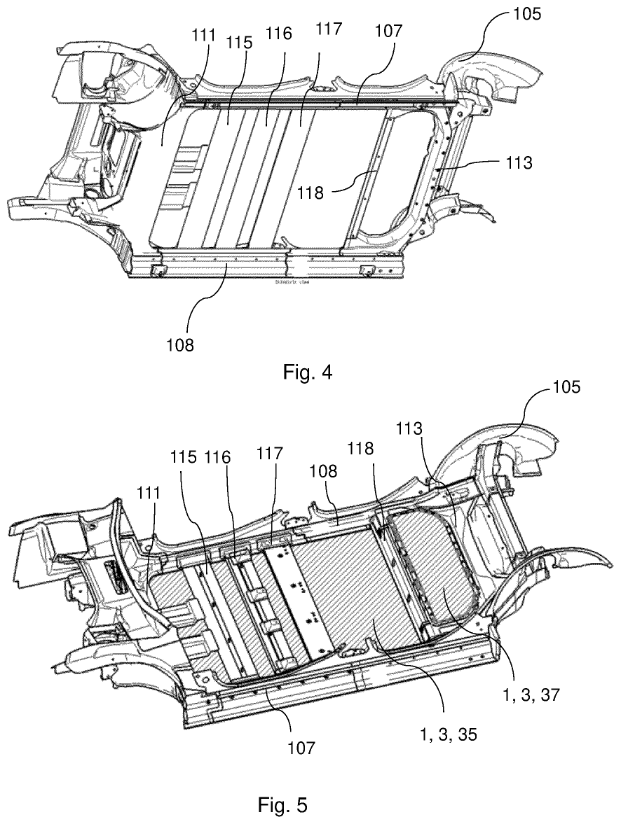

Only the floor pan 105 without the drive battery 1 is shown in a perspective view from below in FIG. 4. As is shown in FIG. 4, the floor pan 105 behind front wheel arches, or behind a front axle, respectively, has a front crossmember structure 111 having a so-called front bulkhead which delimits the passenger cabin toward the front in relation to a vehicle front end and connects front ends of the side skirts 107 and 108 to one another. Furthermore, the floor assembly 105 in front of rear wheel arches, or in front of a rear axle, respectively, has a rear crossmember structure 113 which connects rear ends of the side skirts 107 and 108 to one another and is disposed in the region of a rear seat bench, which is not illustrated and forms a second seat row of the motor vehicle. Furthermore, the floor pan 105 between the front crossmember structure 111 and the rear crossmember structure 113 has further crossmembers such as the seat crossmembers 115, 116, 117 in the region of a front seat row and of a B-pillar of the body 100. A heelboard crossmember 118, which likewise forms a further crossmember, is disposed in the region of the rear seat row. All crossmembers 115, 116, 117, 118 run between the left side skirt 107 and the right side skirt 108 and are connected thereto. The region between the side skirts 107 and 108 and the respective crossmember structures 111 and 113, or the further crossmembers 115, 116, 117, 118, respectively, is open. The floor pan 105 is configured without a floor panel between these members.

The floor pan 105 having the assembled drive battery 1 is shown in a perspective view from obliquely above in FIG. 5. The hatched areas between the side skirts 107 and 108 as well as the front crossmember structure 111 and the rear crossmember structure 113 of the floor pan 105 show an upper side of the drive battery 1, in particular of the drive battery housing 3 and of the ancillary housing 37, in the open regions between the respective members of the floor pan 105. In the hatched areas, the upper side of the drive battery 1 forms a base of the passenger cabin 109 and thus replaces a conventional floor panel. As can furthermore be seen in FIG. 5, the drive battery 1 extends from a front crossmember structure 111 having a bulkhead up to a rear crossmember structure 113 which connects rear ends of the side skirts 107 and 108 to one another, i.e. up to a rear wheel arch of the floor pan 105 below a rear seat bench that forms the second seat row.

Overall, an assembly sealing flange 36 of the drive battery housing 3 bears on the corresponding constituent parts of the floor pan 105 so as to seal in a completely encircling manner, such that the drive battery housing 3 and the floor pan 105 form in an interacting manner a fluid-tight base of the passenger cabin 109 of the motor vehicle. The encircling assembly sealing flange 36 in this exemplary embodiment is situated in a sealing plane.

In comparison to a conventional floor pan of a body, the floor pan 105 has no floor panel and thus has voids between the adjacent crossmembers/crossmember structures. These voids are closed by the drive battery housing 3, or the ancillary housing 37, respectively. In the present exemplary embodiment, 65% of the floor pan 105 between the front crossmember structure 111 and the heelboard member 118 without the drive battery housing 3 between the side skirts 107, 108 and the crossmember structures 111 and 113 are open in the downward direction.

The drive battery 1, in addition to the drive battery housing 3, has the ancillary housing 37 which is attached to the drive battery housing 3 in the rear region of the drive battery housing 3, in the region below the rear seat bench, thus behind the heelboard crossmember 118. Electrical and electronic components of the drive battery 1, such as an output electronics unit, for example, are accommodated in the ancillary housing 37. The ancillary housing 37 protrudes into the intermediate space between the heelboard crossmember 118 and the rear crossmember structure 113. An upper side of the drive battery housing 3 is configured to be substantially flat. As can be seen in FIG. 3, the latter is formed from a housing lower part 33 and a housing upper part 35, wherein the housing lower part 33 has a housing lower part flange 34 and the housing upper part 35 has a housing upper part flange 36, wherein the housing lower part 33 and the housing upper part 35 are connected to one another by way of the housing lower part flange 34 and the housing upper part flange 36, and wherein the housing upper part flange 36 is configured to assemble the drive battery housing 33 on the floor pan 105. A seal 37 is disposed between the housing upper part flange 36 and the housing lower part flange 34. Furthermore, the seal 19 is disposed between the housing upper part flange 36 and the floor assembly 105.

The drive battery housing 3 is connected to the floor pan 105 by way of the screw connections 21 by way of the assembly sealing flange 34, 36. Furthermore, the drive energy storage housing 3, or the housing upper part 35, respectively, is connected to the crossmembers 115, 116, 117, 118 by way of the screw connections 23.

1.-26. (canceled)

27. A drive battery for a motor vehicle, comprising:
a drive battery housing which has a cover wall and a base wall;
a battery cell layer having a multiplicity of battery cells, which are arranged vertically and next to one another; and
a support layer, wherein the support layer and the battery cell layer are disposed in the drive battery housing,
wherein the battery cell layer is adhesively bonded across a large area, to the cover wall via an upper adhesive layer and to the support layer via a lower adhesive layer, and
the support layer is further adhesively bonded to the base wall via a further adhesive layer.

28. The drive battery according to claim 27, wherein
each battery cell is composed of a battery cell housing in which a jelly roll is received,
an upper end side of the battery cell housing is in each case adhesively bonded to the cover wall, and
a lower end side of the battery cell housing is in each case adhesively bonded to the support layer.

29. The drive battery according to claim 27, wherein
the battery cell layer is formed from a multi-chamber structure having a multiplicity of vertical chambers in which, in each case, one or a plurality of jelly rolls are received,
an upper end side of the multi-chamber structure is adhesively bonded to the cover wall, and
a lower end side of the multi-chamber structure is adhesively bonded to the support layer.

30. The drive battery according to claim 27, further comprising:
a battery cell contacting system embedded in the upper adhesive layer and/or in the lower adhesive layer.

31. The drive battery according to claim 30, wherein
the battery cell contacting system, by way of both contacting terminals, is embedded in the upper adhesive layer.

32. The drive battery according to claim 27, wherein
one degassing opening is formed in each battery cell in a side which faces the support layer.

33. The drive battery according to claim 32, wherein
a clearance is provided in the support layer in each case in a region of the degassing openings of the battery cells, and
adjacent clearances are connected to one another by degassing ducts.

34. The drive battery according to claim 27, wherein
the support layer is formed from a foamed plastics material.

35. The drive battery according to claim 27, wherein
the cover wall is configured as a heat exchanger for temperature control of the battery cell layer.

36. The drive battery according to claim 27, wherein
the support layer is configured as a heat exchanger for temperature control of the battery cell layer.

37. The drive battery according to claim 27, wherein
heat-exchange devices are provided between the battery cells, or
heat-exchange devices are provided on shell faces of the battery cells, respectively.

38. The drive battery according to claim 27, wherein
the cover wall and the base wall are connected to one another by a flange connection, and form a fluid-tight drive battery housing.

39. The drive battery according to claim 27, wherein
the base wall is provided on an inside thereof with a heat-protection layer.

40. The drive battery according to claim 27, wherein
the base wall and/or the cover wall are provided on an inside thereof with an electrical insulation layer.

41. The drive battery according to claim 27, wherein
the base wall and/or the cover wall are formed from aluminum or from an aluminum alloy or a steel material or a fiber-reinforced plastics material.

42. The drive battery according to claim 27, wherein
the drive battery is configured to be assembled on a floor pan of a body of the motor vehicle, wherein the floor pan has a left longitudinal member and a right longitudinal member, and
the drive battery, or the drive battery housing, is assembled on the floor pan from below, respectively, wherein the cover wall at least in portions forms a base of the floor pan.

43. A motor vehicle, comprising:
a body; and
a drive battery according to claim 27.

44. The motor vehicle according to claim 43, wherein
the body has a floor pan having a left longitudinal member and a right longitudinal member, and
the drive battery is assembled on the floor pan from below, wherein the assembled drive battery at least in portions forms a base of the floor pan.

45. The motor vehicle according to claim 44, wherein
the drive battery and the floor pan form in an interacting manner a fluid-tight base of a passenger cabin of the motor vehicle, wherein a fluid-tightness of the passenger cabin is established only by an interaction between the drive battery and the floor pan.

46. The motor vehicle according to claim 44, wherein
the drive battery is embodied and connected to the floor pan in such a manner that the drive battery increases a body stiffness for a driving operation of the motor vehicle and the drive battery increases a body strength for a load arising in an event of a collision of the motor vehicle.

47. A method for producing a drive battery for a motor vehicle, the method comprising the steps of:
disposing a cover wall of a battery housing or a battery cell contacting system, and a battery cell layer, on top of one another;
filling intermediate spaces between individual layers and battery cells of the battery cell layer with a liquid foam precursor product; and
foaming, by way of reaction of the liquid foam precursor product after the filling procedure, so as to form a foamed material which adhesively bonds the cover wall, or the battery cell contacting system, and the battery cell layer to one another.

48. The method according to claim 47, wherein,
in the step of disposing, a support layer is additionally disposed, or
after the step of foaming, the support layer is adhesively bonded to the battery cell layer.

49. The method according to claim 48, wherein,
in the step of disposing, a base wall of the battery housing is additionally disposed, or
after the step of foaming, the base wall is adhesively bonded to the support layer.

50. A method for producing a drive battery for a motor vehicle, the method comprising the steps of:
disposing a base wall of a battery housing, a support layer, a battery cell layer, and optionally a battery cell contacting system, on top of one another;
filling intermediate spaces between individual layers and battery cells of the battery cell layer with a liquid foam precursor product, in a form of a bi-component mixture or a multi-component mixture;
foaming, by way of reaction of the foam precursor product after the step of filling, so as to form a foamed material which adhesively bonds the base wall, the support layer, optionally the battery cell contacting system, and the battery cell layer to one another.

51. The method according to claim 50, wherein,
in the step of disposing, a cover wall is additionally disposed, or
after the step of foaming, the cover wall is adhesively bonded to the support layer.

52. The method according to claim 50, wherein during the step of foaming, participating layers are mutually compressed or braced.

53. The method according to claim 47, wherein during the step of foaming, participating layers are mutually compressed or braced.
